(19) United States
(12) Patent Application Publication
(10) Pub. No.: US 2019/0303976 A1
(43) Pub. Date: Oct. 3, 2019

(54) SYSTEM AND METHOD FOR FULFILLING DIGITAL ADVERTISING REQUESTS WITHOUT STORING OR PROVIDING PERSONALLY IDENTIFIABLE INFORMATION ABOUT A USER TO AN EXTERNAL ENTITY

(71) Applicant: SuperAwesome Trading Limited, London (GB)

(72) Inventors: JOSHUA NATHANAEL WÖHLE, LONDON (GB); DANIEL MARIAN ZURAWSKI, LONDON (GB)

(21) Appl. No.: 16/224,701

(22) Filed: Dec. 18, 2018

Related U.S. Application Data
(60) Provisional application No. 62/650,169, filed on Mar. 29, 2018.

(51) Int. Cl. G06Q 30/02; G06F 21/62

(52) U.S. Cl. CPC G06Q 30/0271; G06F 21/6263

(57) ABSTRACT

A method for providing an advertisement to a user device while preventing the availability of user personally identifiable information (PII) to an advertising supplier.

### RELATED APPLICATIONS

This application claims priority from U.S. provisional application No. 62/650,169 filed on Mar. 29, 2018 which is incorporated by reference herein in its entirety.

### FIELD

This application relates to internet security and more particularly to ensuring no personally identifiable information are compromised when serving advertisements.

### BACKGROUND

In conventional online advertising systems, when a user visits a mobile application or website (an App), a request for an advertisement is sent to an advertising exchange—a technology platform to enable web publishers to manage their advertising space inventory, display advertisements, and receive revenue (also known as a Supply Side Platform or SSP). A problem with conventional SSPs is that—with each request for an advertisement—personally identifiable information of the user is sent in the form of persistent identifiers, such as cookies. Requests for advertisements also include signals from a user's device, for example device identifiers or the user-agent string (information such as browser's name and version, rendering engine, device's model number, operating system and its version). Taken together, the user-agent string and device identifiers create a targetable advertising ‘fingerprint’ that advertisers can use to, for example, create advertisements that are directed toward an individual user.

Due to various legal restrictions and requirements, providing personally identifiable information and/or fingerprints is a concern, and may not be legal in some jurisdictions and situations, such as when the user is a minor/child. Embodiments herein provide a system and method for enabling the use of advertising without storing or providing personally identifiable information about a user to an external entity, e.g., an SSP.

### SUMMARY OF THE EMBODIMENTS

A method for providing an advertisement to a user device while preventing availability of user personally identifiable information (PII) to an advertising supplier including receiving a request for an advertisement from the user device, said request including user PII and device information about the user device, modifying said user PII, modifying said device information, and transmitting a modified ad request having said modified PII and said modified device information to the advertising supplier.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is an illustration of an environment in which one or more embodiments operate.

FIG. 2 is a flowchart describing the operation of providing an advertisement while removing personally identifiable information and device information in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

An embodiment of the present invention is now described with reference to the figures where like reference numbers indicate identical or functionally similar elements. Also in the figures, the left most digits of each reference number corresponds to the figure in which the reference number is first used.

In the embodiments described herein, when a user uses an Application or a website that can display advertisements, a request for an advertisement is sent to a SSP in order to fulfil the request with an advertisement. Features of the present embodiments including having the advertisement served to the user without disclosing the user's personally identifiable information or device information to the SSP in order to prevent the SSP from accurately creating a user fingerprint. However, the information provided is sufficient such that the SSP is able to operate using standard advertising protocols and systems in order to continue performing their required function of serving an advertisement to users.

For example, the SSP requires some PII and fingerprint information, present embodiments, modifies this information so that information is sent to the SPP as part of an advertisement request, however, this information in the request has had the PII and fingerprint information modified.

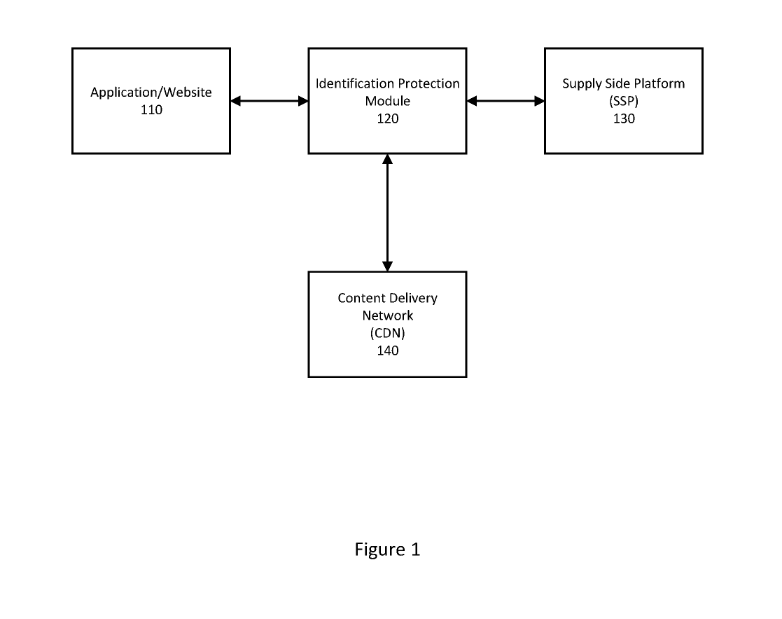

FIG. 1 is an illustration of the environment system in which one or more embodiments operate. In the example set forth herein, the advertisement is in video format, however, embodiments also operate with other types of advertisements, e.g., display advertisements. For example, if display or rich media are used the system can mirror the ad in a separate section, e.g., in a parallel universe, one universe being a server in identification module 120 and another being in the application/website 110. FIG. 1 includes an Application or website 110 which can communicate, e.g., using a wide area network such as the Internet, with Identification Protection Module (IPM) 120. The IPM 120 also communicates with a supply side platform (SSP) 130 and a Content Delivery Network (CDN) 140. The operation of each is set forth below.

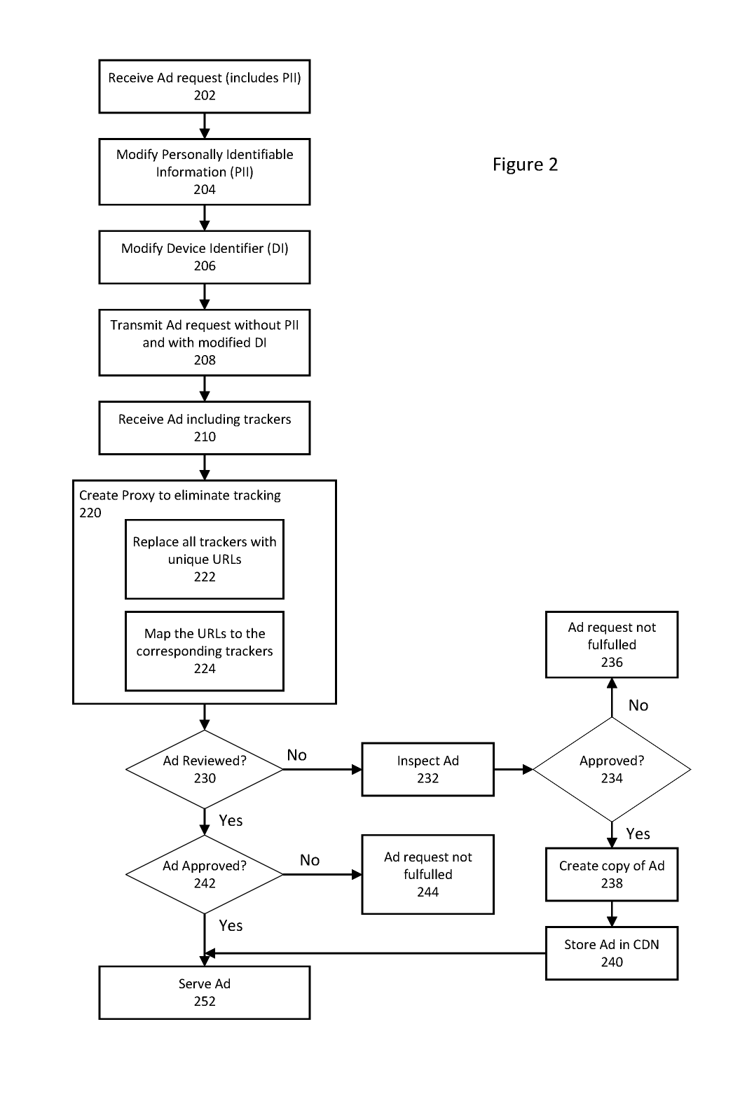

FIG. 2 is a flowchart describing the operation of providing an advertisement while removing personally identifiable information and device information in accordance with embodiments.

An application/website 110 in use by a user sends a request for an advertisement. As described above, this request is normally sent to an SSP 130 and this request includes PII and device information signals from a user's device, for example device identifiers or the user-agent string (information such as browser's name and version, rendering engine, device's model number, operating system and its version). Taken together, the user-agent string and device identifiers (fingerprint information) create a targetable advertising ‘fingerprint’ that advertisers can use to, for example, create advertisements that are directed toward an individual user. In the present embodiment, the advertisement (Ad) request is received 202 by the identification protection module (IPM) 120. As noted above, the Ad request includes PII and fingerprint information.

In embodiments, the type of information included in PII may be defined by law. The US Federal law known as the Children's Online Privacy Protection Act (COPPA) determines personally identifiable information as any information that refers, is related to, or is associated with an identified or identifiable individual, including, but not limited to: (i) first and last name, (ii) home or other physical address, (iii) e-mail address or online contact information, screen or user name or other unique identifier, (iv) telephone number, (v) social security number, (vi) persistent identifier used for any purpose other than for a publisher's first-party internal operations (as defined under COPPA), including but not limited to cookies or unique device IDs, or (vii) photograph, video or audio file or geolocation information—collectively, PII. Each request for an advertisement also includes: (a) the originating internet protocol (IP) address, (b) the user-agent string of the device and often includes: (i) the device identifier (ID), or a specific device identifier for advertising (IDFA), collectively, DI.

Due to various legal restrictions and requirements, providing personally identifiable information and/or fingerprints/DI is a concern, and may not be legal in some jurisdictions and situations, such as when the user is a minor/child. Embodiments herein provide a system and method for enabling the use of advertising without storing or providing personally identifiable information about a user to an external entity, e.g., an SSP.

In particular, the IPM 120 (a) modifies 204 or replaces PII such that the information no longer fit the criteria of being deemed PII and (b) modifies 206 the DI sent to a SSP in a manner which still allows standard advertising protocols and systems to continue performing their required function of serving an advertisement to users while not enabling the SSP to accurately fingerprint the user.

An example of how the IPM 120 achieves this is now set forth. It is understood that this is merely one example as to how the information can be modified and that other techniques can be used without departing from the scope of the embodiments.

The IPM 120 modifies 206 the IP address of the user's device/website before sending that information to the SSP 130. In one embodiment, the IPM 120 manipulates the last 8 bits of the IP address (or the last 3 digits as it is most commonly referred to) by setting them to “0”. This allows for an approximate geolocation look-up (required for location-based advertising that would target regions such as New York or London) whilst preventing an inventory buyer from identifying a particular person since the IP address is no longer unique, or a person's more precise geo-location, e.g., at block level.

The IPM 120 also modifies 206 the Device ID prior to sending that information to the SSP 130. In one embodiment, the IPM 120 replaces the device ID with a custom ID and that, in an embodiment, is unique per user per App (therefore, the same user using multiple apps would appear like different users to an SSP 130). The modification looks like a real device ID from the perspective of an SSP 130. In one embodiment, the custom ID is generated using a hashing algorithm.

The IPM 120 also modifies 206 the specific device identifier for advertising (IDFA) prior to sending that information to the SSP 130. In one embodiment, the IPM 120 replaces the IDFA with a custom ID that, in an embodiment, is unique per user per app. Therefore, the System has the effect of eliminating the tracking of a user across different apps. The same user using multiple apps appears as different users. In one embodiment, the modification works as follows (although it is envisioned that many other types of modifications can be used): A custom user identifier is used and a hash value (a number generated from a strong of text) is inserted after one or more of multiple characters in the IDFA, e.g., after one or more of the 8^{th}, 12^{th}, 16^{th}, and 20^{th} characters.

The IPM 120 also modifies 206 the advertising ID (Ad ID) prior to sending that information to the SSP 130. In one embodiment, the IPM 120 replaces the Ad ID with a custom ID that, in an embodiment, is unique per user per app. Therefore, the System has the effect of eliminating the tracking of a user across different apps. The same user using multiple apps appears as different users. In one embodiment, the modification works as follows (although it is envisioned that many other types of modifications can be used): A custom user identifier is used and a hash value (a number generated from a strong of text) is inserted after one or more of multiple characters in the IDFA, e.g., after one or more of the 8^{th}, 12^{th}, 16^{th}, and 20^{th} characters.

The IPM 120 also modifies 206 the user-agent string in the HyperText Transfer Protocol (HTTP) header prior to sending that information to the SSP 130. In one embodiment, the IPM 120 replaces the user-agent string with a generic list of configuration settings, e.g., maintained by the IPM 120, which are not unique and can include: (a) the browser type, e.g., Chrome, Firefox, Internet Explorer, Safari, etc., (b) the environment, e.g., desktop, mobile, video on demand, etc., (c) the device type, e.g., iPhone, Android Galaxy, Blackberry, etc., (d) the type of operating system (OS), e.g., Android, iOS, Windows, etc., (e) the OS version, e.g., iOS 10, 11, 12, Android 4, 5, 6, etc.

The IPM 120 then transmits 208 the Ad request to the SSP 130 without PII and with modified DI so that the SSP 130 cannot successfully identify the user or the device. However, the information sent is in the format expected by the SSP 130 so that the information provided is sufficient for the SSP to operate using standard advertising protocols and systems in order to continue performing their required function of serving an advertisement to users.

That is, the request for an advertisement no longer contains PII, and the DI is modified such that the SSP 130 cannot correlate any of the data within the request to any particular user. This ensures that (a) the publisher of the App from which the request originates is not violating COPPA (no PII is provided to a third party); (b) any of the advertisers involved in bidding for or winning this particular advertisement impression (described below) is not violating COPPA, as even if their systems attempt to collect profile-based data to inform their purchasing decisions, they are not able to do so; and (c) no third party that is bidding on advertising impressions can collect PII or build user profiles based on DI, which when done by third parties who are not intending to buy the advertising space is a practice known as “data leakage.”

The SSP 130 generates the information necessary for an advertisement and transmits this to the IPM 120. The IPM 120 receives 210 the Ad which includes Ad trackers. In an embodiment, the IPM 120 receives 210 a video advertising serving template (VAST) tag which, in an embodiment, uses standard extensible markup language (XML) and can include all information needed to play a video advertisement. The SSP 130 can use different formats for the Ad, e.g., Video Player Ad Interface Definition (VPAID), Video Multiple Ad Playlist (VMAP), and Mobile Rich Media Ad Interface Definition (MRAID), script based ads including static display, rich media, Immersive Augmented Reality (AR), Augmented Virtual Reality (VR), etc.

This VAST information may include Trackers which can include (a) the location of the video file to be played as an advertisement, (b) the systems to be notified of various events related to playing the Ad, such as when the video is clicked on, when it starts playing, when the video is played through 25%, 50%, 75%, and 100%, (c) the information to be sent back to the SSP 130 about the Ad displaying on the user's device, including PII and DI that can be used for audience targeting, (d) the information to be sent back to fraud detection services employed by the advertiser, which may include PII and DI.

There are other mechanisms that may determine which VAST tag the SSP sends. These mechanisms can include (but are not limited to) auctions, bidding, targeting, etc. The IPM 120 does not control and is not concerned about this, however, the IPM 120 requires a VAST tag (or other Ad format) to be returned in order to serve the advertisement.

Due to the modifications to the PII and DI performed above by the IPM 120, all other processes involved in a conventional “bidding” on the advertising request will behave as normal. They will use the information such as the (modified) device ID, IDFA, IP, etc. in order to determine if they want to buy each and every advertising impression (individually). From the perspective of these conventional advertising purchasing modules, everything looks and appears normal.

Each of the Trackers, if sent to a child/minor unmodified, would potentially collect data on the child/minor for profile-based advertising or other purposes that are prohibited by COPPA. In order to prevent this from happening, the IPM 120 inspects each SSP-supplied VAST tag Tracker and transforms them so they do not collect PII.

The IPM 120 transforms each Tracker applying a process called “proxying” 220 which includes redirecting a request through a third-party server, while still responding in the way the requestor (application/website 110) expects, hence preserving its functionality. In this example, the IPM 120 functions as the third-party server. In essence, the IPM 120: (a) replaces 222 all Trackers with unique Uniform Resource Locators (URLs); and (b) maps 224 these unique URLs to the original Trackers.

Any subsequent requests for “proxy URLs” will trigger a request to the mapped URLs only. In this way, the advertiser's VAST tag returns the information expected, but provided by the third-party server and not the user's device. In an embodiment, in order for the System to do this for millions of ad impressions, it applies a caching function as described below.

In this embodiment, each time a request is returned from a SSP 130, the IPM 120 reviews the creative (the content of the advertisement itself) to determine 230 whether it has been inspected before. In one embodiment, this is accomplished by downloading the first 50 bits of the creative and comparing them against a previously inspected and approved creative (of the same 50 bits). It is envisioned that additional identification techniques may be used.

If the IPM 120 has not seen the creative before, it stops the transaction and transfers the creative for inspection 232, e.g., to an inspection module (not shown). In an embodiment, creatives can be inspected manually. Manual review enables suitability checks (using a suitability filter based on, for example, pre-determined rules, e.g. age-appropriate for children). The review team “approves” or “rejects” the creative based on those rules. In an alternate embodiment, the approval process can be done automatically by the inspection module using, for example, video analysis and categorization, machine learning algorithms can be trained and used to automatically approve/reject (or flag for additional analysis) the creative.

Once a creative is approved 234, the IPM 120 creates 238 a copy of it and stores it in its dedicated content repository, the content delivery network (CDN) 140.

If the IPM 120 has previously seen this creative but is still waiting the completion of the (manual) review, the System will pause the advertising process so that the creative is not displayed. In one embodiment it drops the VAST tag and will not fulfil 236 the advertisement request.

If the IPM 120 has seen the creative before and has rejected it, e.g. for not adhering to the suitability rules, the IPM 120 will not fulfil 244 the advertisement request.

Only if the IPM 120 has previously seen and approved the creative under suitability rules, will the advertisement by served 252 to a user.

At this stage: (a) the VAST tag received from the SSP 130 no longer contains any Trackers directly (all of them have been proxied as described above), (b) the video contained in the VAST tag has been reviewed and judged appropriate for the audience that is about to see it, and (c) the creative that is being served is a copy of the creative that has been reviewed and is served directly from the CDN. This prevents malicious parties from switching out the creative after having passed the System's approval process.

The IPM 120 has successfully removed all PII and transmits the VAST tag to the user's device 110 in order to play/show the advertisement.

All events related to the advertisement playing on the user's device are triggered as with conventional advertising models, but since they are being proxied using the IPM 120 (as described above), they are sent through to the SSP 130 from the third-party server. This means all systems continue working and obtain the data they need, e.g., when the advertisement starts, how long it plays, etc., but they do not get access to any PII or complete DI that would have been exposed if they were to get the request directly from the user's device 110.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements are not in direct contact with each other, but yet still co-operate or interact with each other, or are structured to provide a thermal conduction path between the elements.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of embodiments. This description should be read to include one or at least one and the singular also includes the plural unless it is obvious that it is meant otherwise. The use of the term and/or is intended to mean any of: “both”, “and”, or “or.”

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A method for providing an advertisement to a user device while preventing availability of user personally identifiable information (PII) to an advertising supplier comprising:
receiving a request for an advertisement from the user device, said request including user PII and device information about the user device;
modifying said user PII such that the modified PII is no longer PII;
modifying said device information to prevent the tracking of a user across different applications; and
transmitting a modified ad request having said modified PII and said modified device information to the advertising supplier.

2. The method of claim 1, further comprising:
receiving a first advertisement from the advertising supplier that includes advertising tracking information;
replacing said advertising tracking information with a new uniform resource locator (URL); and
transmitting a modified first advertisement to the user device with the new URL.

3. The method of claim 2, wherein the tracking information includes a first URL of a first creative.

4. The method of claim 3, further comprising:
generating a safe first creative which does not include tracking information; and
storing said safe first creative at said new URL.

5. The method of claim 4, further comprising:
inspecting said first creative based on an audience suitability filter; and
approving said first creative if said first creative passes the suitability filter.

6. The method of claim 2, wherein said tracking information includes a first creative, and further comprising:
generating a safe first creative which does not include tracking information; and
storing said safe first creative at said new URL.

7. The method of claim 6, further comprising:
inspecting said first creative based on an audience suitability filter; and
approving said first creative if said first creative passes the suitability filter.

8. The method of claim 2, wherein said tracking information include a first creative, and further comprising:
inspecting said first creative based on an audience suitability filter; and
approving said first creative if said first creative passes the suitability filter.

9. A system for providing an advertisement to a user device while preventing availability of user personally identifiable information (PII) to an advertising supplier comprising:
an identification protection module to receive a request for an advertisement, said request including user PII and device information about a user device, to modify said user PII such that the modified PII is no longer PII, to modify said device information to prevent the tracking of a user across different applications, to transmit a modified ad request having said modified PII and said modified device information to the advertising supplier.

10. The system of claim 9, wherein said identification protection module receives a first advertisement from the advertising supplier that includes advertising tracking information, replaces said advertising tracking information with a new uniform resource locator (URL), and transmits a modified first advertisement to the user device with the new URL.

11. The system of claim 10, wherein the tracking information includes a first URL of a first creative.

12. The system of claim 11, wherein said identification protection module generates a safe first creative which does not include tracking information, and stores said safe first creative at said new URL.

13. The system of claim 12, further comprising
an inspection module that inspects said first creative based on an audience suitability filter, and approves said first creative if said first creative passes the suitability filter.

14. A user protection system stored on a computer readable medium, wherein the user protection system is manufactured by a process comprising
receiving a request for an advertisement from a user device, said request including user personally identifiable information (PII) and device information about the user device;
modifying said user PII such that the modified PII is no longer PII;
modifying said device information to prevent the tracking of a user across different applications
transmitting a modified ad request having said modified PII and said modified device information to an advertising supplier.

15. The system of claim 14 further comprising:
receiving a first advertisement from the advertising supplier that includes advertising tracking information;
replacing said advertising tracking information with a new uniform resource locator (URL); and
transmitting a modified first advertisement to the user device with the new URL.

16. The system of claim 15, wherein the tracking information includes a first URL of a first creative.

17. The system of claim 16, further comprising:
generating a safe first creative which does not include tracking information; and
storing said safe first creative at said new URL.

18. The system of claim 17, further comprising:
inspecting said first creative based on an audience suitability filter; and
approving said first creative if said first creative passes the suitability filter.

19. The system of claim 15, further comprising:
generating a safe first creative which does not include tracking information; and
storing said safe first creative at said new URL.

20. The system of claim 15, further comprising:
inspecting said first creative based on an audience suitability filter; and
approving said first creative if said first creative passes the suitability filter.
